(19) United States
(12) Patent Application Publication
(10) Pub. No.: US 2012/0018939 A1
(43) Pub. Date: Jan. 26, 2012

(54) DIRECT CLAMP GRIPPER PROVIDING MAXIMIZED PART CLEARANCE

(75) Inventor: James Thomas Buckley, Roseville, MI (US)

(73) Assignee: ACME MANUFACTURING COMPANY, Auburn Hills, MI (US)

(21) Appl. No.: 12/839,805

(22) Filed: Jul. 20, 2010

(51) Int. Cl. B23Q 1/64

(52) U.S. Cl. 269/57

(57) ABSTRACT

A finishing system for finishing a part using a robot may include a staging fixture, a gripper, and a regrip fixture. The part may include an inner surface, a protrusion, and a notch. The staging fixture may include first pads adapted to engage the protrusion. The gripper may be adapted to couple to the robot and may include a first outer surface and second pads. The first outer surface may be shaped to engage the inner surface of the part and the second pads may be adapted to clamp the protrusion on the part. The regrip fixture may include a tab adapted to engage the notch.

### FIELD

The present disclosure relates to robotic finishing systems and, more particularly, to direct clamp grippers providing maximized part clearance.

### BACKGROUND

This section provides background information related to the present disclosure which is not necessarily prior art.

Metalworking of cast metal articles such as prosthetic knee implants typically requires surface finishing such as buffing, polishing, deburring, grinding and satin finishing. Traditionally, these finishing steps were performed by hand. More recently, however, automated processing replaced most manual operations. As compared to manual finishing, automated finishing provides greater efficiency, precision, and safety.

An important aspect of robotic finishing knee implants is the need to manipulate the implant to expose all surfaces to a finishing device such as a wheel or belt. To accomplish this, the implant must be held by the robot and maneuvered to various orientations relative to the finishing device. Importantly, the robot must hold the implant against the finishing device with pressure without marring the surface of the implant when picking it up or putting it down.

One technique for enabling a knee implant to be picked up and manipulated by a robot in a finishing operation is to mount the knee implant to a metal support bar. In this technique, the knee implant is fixed to a central region of a metal bar through the use of fasteners such as screws. The bar laterally extends beyond the both outboard edges of the knee implant to provide two graspable handles for the robot. The robot may then use jaws to clamp onto one handle of the bar and manipulate the knee implant relative to the finishing device. The knee implant and bar assembly may then be set down while the robot repositions its jaws to the other graspable handle of the bar. The knee implant may then be further manipulated relative to the finishing device. Mounting a knee implant to a support bar is labor intensive and involves significant costs associated with the support bars.

A second technique for enabling robotic manipulation of a knee implant is to secure a gripper to a robot having jaws. The gripper allows the robot to directly clamp the knee implant via actuation of the jaws. One type of a conventional gripper includes two opposing clamp bars that clamp onto two posts extending from an inner surface of the knee implant. The robot positions the clamp bars normal to the outboard edges of the knee implant on opposite sides of the two posts, and then brings the clamp bars together to clamp the posts. The robot closes its jaws to bring the clamp bars together and opens its jaws to move the clamp members apart. When clamping the posts, the clamp bars extend across a cruciate gap separating two condyles of the knee implant from which the two posts extend. Using a gripper such as the one described above for finishing knee implants requires manually finishing the cruciate gap obstructed by the clamp bars during automated finishing.

Thus, there is a need for a finishing system that enables the direct clamping of knee implants while providing maximized part clearance.

### SUMMARY

This section provides a general summary of the disclosure, and is not a comprehensive disclosure of its full scope or all of its features.

A finishing system for finishing a part using a robot may include a staging fixture, a gripper, and a regrip fixture. The part may include an inner surface, a protrusion, and a notch. The staging fixture may include first pads adapted to engage the protrusion. The gripper may be adapted to couple to the robot and may include a first outer surface and second pads. The first outer surface may be shaped to engage the inner surface of the part and the second pads may be adapted to clamp the protrusion on the part. The regrip fixture may include a tab adapted to engage the notch.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a plan view of a robotic finishing system according to the principles of the present disclosure;

FIG. 2 is a perspective view of a part staging fixture according to the principles of the present disclosure supporting a knee implant;

FIG. 3 is a planar view of the part staging fixture of FIG. 2 supporting a knee implant;

FIG. 4 is a perspective view of a direct clamp gripper according to the principles of the present disclosure clamping a post of a knee implant;

FIG. 5 is a perspective view of the direct clamp gripper of FIG. 4 and a knee implant, with the gripper clamping a different post of the knee implant;

FIG. 6 is an exploded perspective view of the direct clamp gripper of FIG. 4;

FIG. 7 is a sectional view of the direct clamp gripper of FIG. 4 and a knee implant, with clamp pads of the gripper positioned to clamp the post;

FIG. 8 is a sectional view of the direct clamp gripper of FIG. 4 and a knee implant, with the clamp pads of the gripper positioned to release the post;

FIG. 9 is a perspective view of a part regrip fixture according to the principles of the present disclosure clamping notches in a knee implant;

FIG. 10 is a side view of a knee implant being transferred between the direct clamp gripper of FIG. 4 and the part regrip fixture of FIG. 9;

FIG. 11 is a sectional view of the part regrip fixture of FIG. 9 and a knee implant, with tabs of the regrip fixture positioned to engage the notches;

FIG. 12 is a sectional view of the part regrip fixture of FIG. 9 and a knee implant, with tabs of the regrip fixture positioned to release the notches; and

FIG. 13 is a perspective view of a direct clamp gripper according to the principles of the present disclosure clamping a post of a knee implant.

Corresponding reference numerals indicate corresponding parts throughout the several views of the drawings.

### DETAILED DESCRIPTION

Example embodiments will now be described more fully with reference to the accompanying drawings.

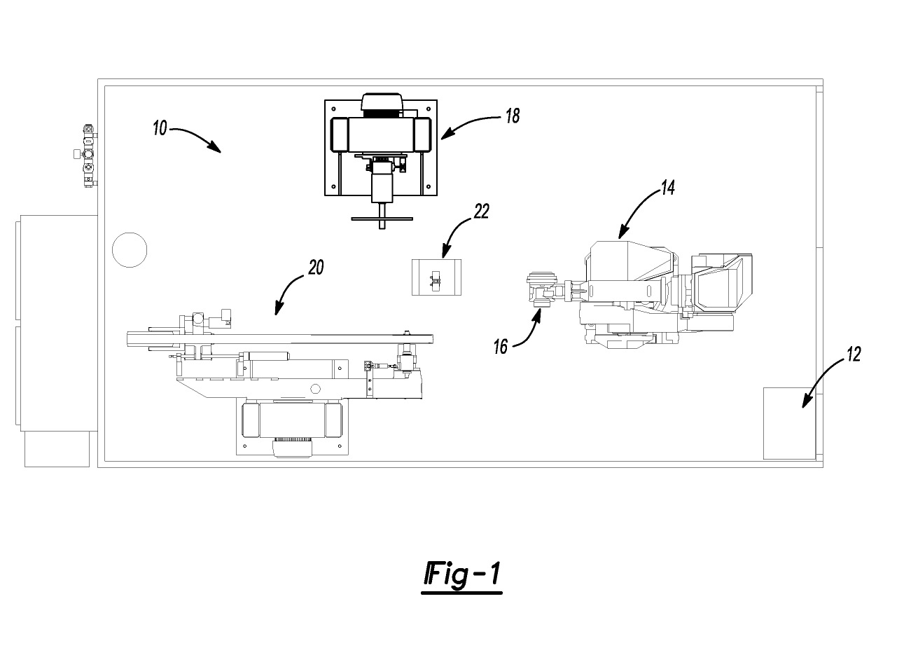

Referring now to FIG. 1, a robotic finishing system 10 used for finishing parts such as knee implants is illustrated. The system 10 includes a part staging fixture 12, a robot 14, a direct clamp gripper 16 coupled to the robot 14, a wheel finishing device 18, a belt finishing device 20, and a part regrip fixture 22. The robot 14 may be a FANUC M7101C 6-Axis robot with a 110-pound payload. The finishing devices 18, 20 may include 5 horsepower dual stacked buff heads or ultra-light front floating heads. The system 10 may include more or less finishing devices.

In operation, the robot 14 picks up a knee implant from the part staging fixture 12 and manipulates the implant relative to the finishing devices 18, 20 to perform buffing, polishing, and the like. To expose all surfaces of the implant to the finishing devices 18, 20, the robot 14 transfers the part to the regrip fixture 22 and regrips the part from an opposite side. Finishing operations are then continued.

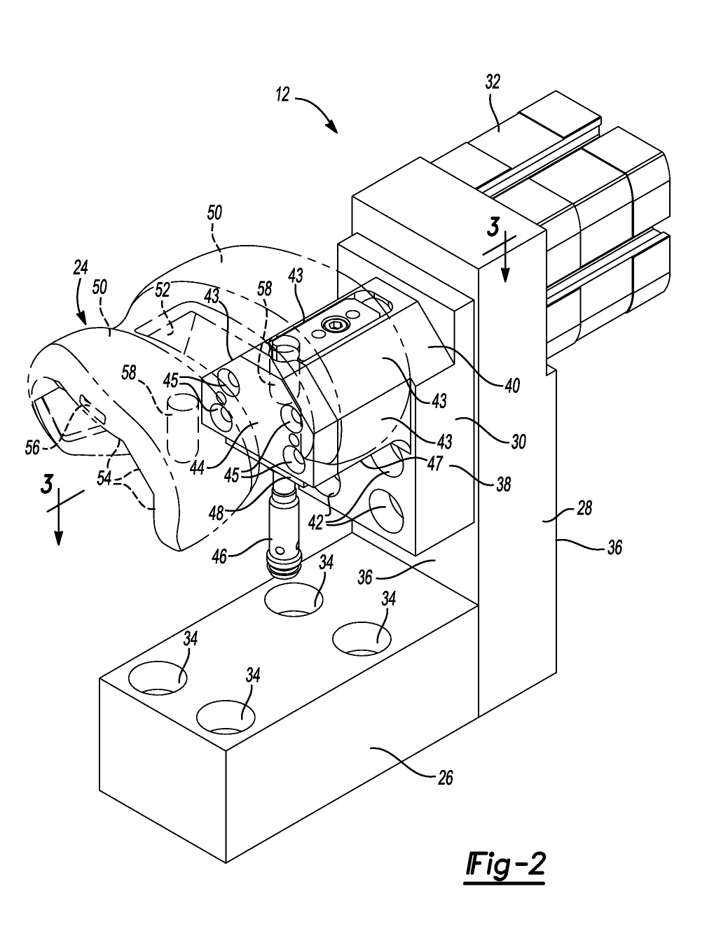

Referring now to FIG. 2, the staging fixture 12 may support a knee implant 24 both before and after the implant 24 is finished in the system 10. Although a knee implant is used throughout this description as an example of the part to be finished, the present disclosure is not limited to tooling for finishing knee implants.

The staging fixture 12 includes a mounting base block 26, a support block 28, a part nesting block 30, and an actuator 32. The mounting base block 26 includes holes 34 in which fasteners may be inserted to fix the staging fixture 12 to, for example, a bedplate. The blocks 26, 28 may include holes (not shown) in which fasteners may be inserted to fix the support block 28 to the mounting base block 26. The support block 28 includes mounting surfaces 36 on which the part nesting block 30 and the actuator 32 are mounted. The mounting surfaces 36 may include holes (not shown) in which fasteners may be inserted to mount the part nesting block 30 and the actuator 32 to the support block 28.

The part nesting block 30 includes a mounting portion 38 and an engaging portion 40. The mounting portion 38 has a rectangular shape and includes holes 42 in which fasteners may be inserted to mount the part nesting block 30 to the support block 28. The engaging portion 40 has a hexagonal shape providing outer surfaces 43. A clamp pad 44 is attached to an end of the engaging portion 40 via fasteners inserted through holes 45 in the clamp pad 44. A proximity sensor 46 is attached to an outer surface 47 of the engaging portion 40 via a sensor bracket 48. The actuator 32 may be a compact pneumatic cylinder that is single acting with a spring return or double acting with a compressed air return.

The implant 24 includes fingers or condyles 50 and a cruciate gap 52 disposed between and separating the condyles 50. The condyles 50 include inner surfaces 54, extraction notches 56 located at outboard edges of the implant 24, and one or more protrusions 58 extending from the inner surfaces 54 adjacent to the extraction notches 56. The outer surfaces 43 of the part nesting block 30 are shaped to substantially conform to the inner surfaces 54 of the implant 24. The protrusions 58 may be posts, as shown, that are integrally formed with the implant 24 or threaded into holes (not shown) provided in the implant 24. Alternatively, the protrusions 58 may be a single rectangular box disposed between the condyles 50.

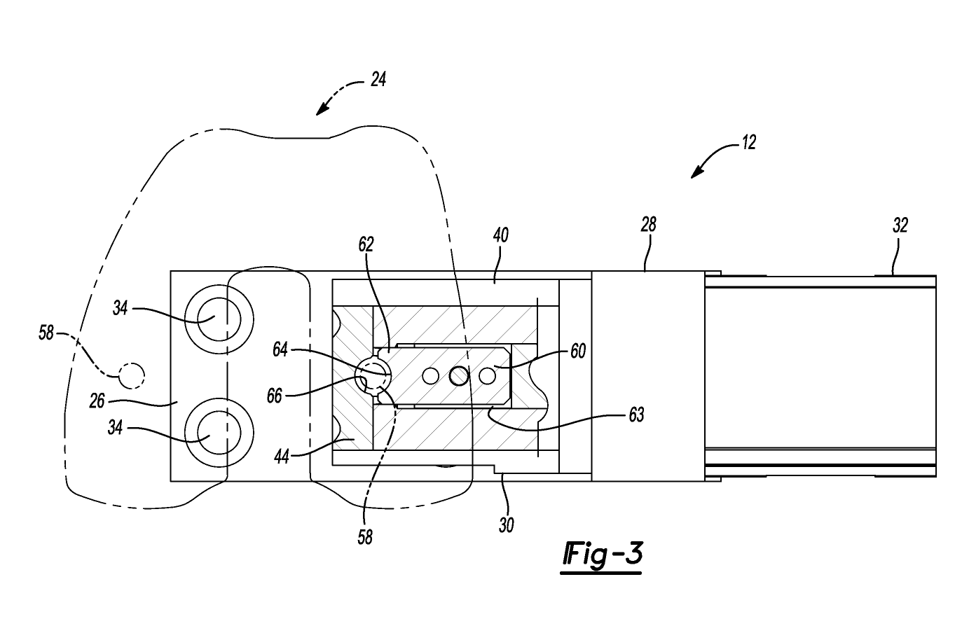

Referring now to FIG. 3, inner components of the staging fixture 12 will now be described. The inner components of the staging fixture 12 include a coupler or pushrod 60 and a clamp pad 62. The pushrod 60 couples the clamp pad 62 to the actuator 32. The pushrod 60 and the clamp pad 62 are slideable within a bore 63 extending through the support block 28 and the part nesting block 30. The clamp pad 62 includes a clamp surface 64 opposing a clamp surface 66 on the clamp pad 44.

Referring to FIGS. 2 and 3, operation of the staging fixture 12 will now be described. The staging fixture 12 engages the inner surfaces 54 of the implant 24 to locate the implant 24, and engages one of the protrusions 58 on the implant 24 to grip the implant 24. The implant 24 may be loaded onto the staging fixture 12 and unloaded from the staging fixture 12 either manually or using a gantry crane (not shown). The outer surfaces 43 of the part nesting block 30 engage the inner surfaces 54 of the implant 24 to locate the implant 24 relative to the staging fixture 12.

The staging fixture 12 grips the implant 24 by actuating the pushrod 60 toward the clamp pad 44 to engage the clamp surfaces 64, 66 on the clamp pads 44, 62 with one of the protrusions 58 on the implant 24. The staging fixture 12 may grip the implant 24 when the proximity sensor 46 detects the presence of the implant 24. The staging fixture 12 releases the implant 24 by actuating the pushrod 60 away from the clamp pad 44 to disengage the clamp surfaces 64, 66 from one of the protrusions 58.

Gripping components and operation of the staging fixture 12 may be identical to those of the gripper 16 or similar to those of the gripper 16 with only minor differences such as sizing. The gripping components of the staging fixture 12 may be sized smaller than the gripping components of the gripper 16, as the staging fixture 12 need not be able to withstand high loads exerted on the implant 24 during finishing. In view of the foregoing, the discussion below regarding the gripping components and operation of the gripper 16 also applies to the staging fixture 12.

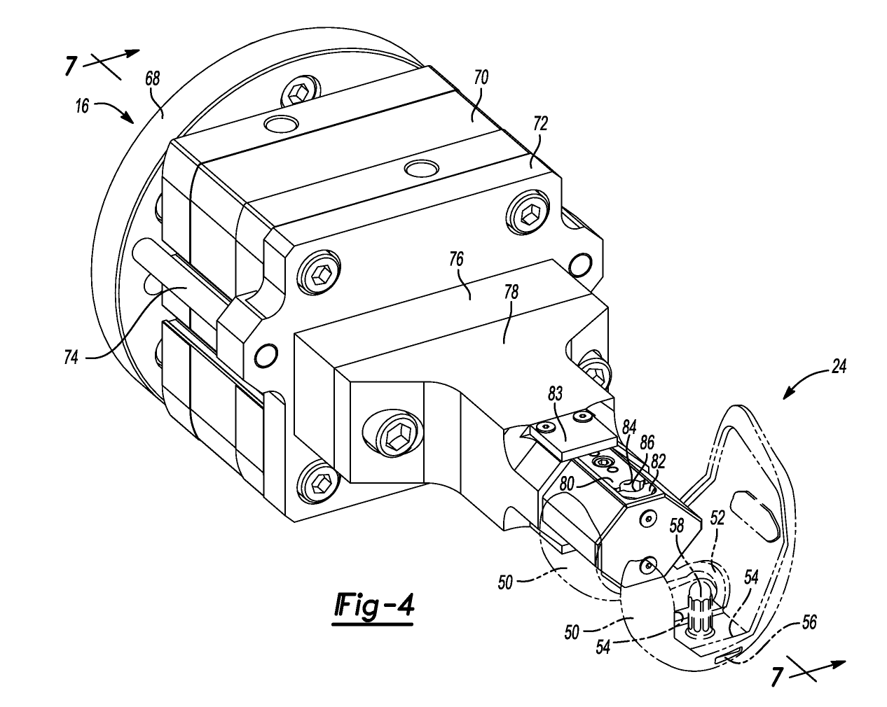

Referring to FIGS. 4 through 6, the gripper 16 includes a first adapter 68, an actuator 70, a second adapter 72, dowel pins 74, a spacer block 76, a support 78, clamp pads 80, 82, and cover plates 83. The clamp pads 80, 82 include clamp surfaces 84, 86, respectively, that are shaped to substantially conform to the contour of the protrusions 58 of the implant 24. Minor differences between the clamp surfaces 84, 86 and the perimeter surfaces of the protrusions 58 may be allowed for ease of manufacture. For example, the perimeter surfaces of the protrusions 58 may taper inward toward the respective ends of the protrusions 58, while the clamp surfaces 84, 86 may be straight.

The first adapter 68 may be a cylindrical plate having a bore 87 extending through the first adapter 68 and may include holes 88, 90, and 92 extending at least partially through the first adapter 68. The holes 88, 90, and 92 may be threaded, unthreaded, straight, countersunk, and/or counterbored depending on the fastener type to be inserted therein. Fasteners 94 are inserted into the holes 88 to couple the gripper 16 to the robot 14 of FIG. 1. The fasteners 94 may be socket head screws, as shown, and the holes 88 may be counterbored.

The actuator 70 may be a single or double acting compact pneumatic cylinder having a rectangular block shape and including a piston 96 therein. The piston 96 includes a shaft 98 including a threaded hole 100 therein. The actuator 70 further includes a bore 102 extending partially through the actuator 70 and holes 104 for fixing the actuator 70. The piston 96 is slideable within the bore 102, and travel of the piston 96 may be limited by the housing of the actuator 70. The holes 104 may be through holes.

The second adapter 72 may be a rectangular plate including a bore 106 and holes 107, 108, 109, and 110 extending at least partially through the second adapter 72. Fasteners 112 are inserted into the holes 92, 104, and 108 to couple the second adapter 72 and the actuator 70 to the first adapter 68. The fasteners 112 may be socket head screws, as shown, and the holes 108 may be counterbored through holes receiving the socket head screws. Dowel pins 74 are inserted into holes 110 and 90.

The spacer block 76 includes a bore 114 and holes 116, 118 extending at least partially through the spacer block 76. The holes 116 may be unthreaded. Dowel pins 120 are inserted into the holes 116 to align the bore 114 relative to the bores 102 and 106. A coupler or pushrod 122 is slideable within the bore 114 and couples end clamping components of the gripper 16 to the piston 96. The pushrod 122 includes a shaft 124 and a flat surface 126 including holes 128, 130 for receiving fasteners such as screws and pins. The shaft 124 of the pushrod 122 is threaded into the hole 100 of the piston 96, and a nut 132 is threaded onto the pushrod 122 to prevent the shaft 124 from backing out of the hole 100. The nut 132 may be a hex jam nut, as shown.

The support 78 may include a mounting portion 133 including holes 134 and an engaging portion 135 including an opening 136, holes 138, holes 140, and an enclosed end 139 including holes 140, and outer surfaces 142. The opening 136 exposes or provides access to the clamp surfaces 84, 86 of the clamp pads 80, 82. The engaging portion 135 may have an octagonal shape providing the outer surfaces 142 of the engaging portion 135 such that the outer surfaces 142 are shaped to substantially conform to the inner surfaces of the implant 24. The outer surfaces 142 may include a horizontal surface that is horizontal relative to ground, an angled surface that is oriented at a reflex angle relative to the horizontal surface, and a side surface that is oriented at a right angle relative to the horizontal surface.

Fasteners 144, such as screws, are inserted into holes 145 in the clamp pads 80 and into the holes 128 in the pushrod 122 to attach the clamp pads 80 to the pushrod 122. When assembled, the surfaces of the clamp pads 80 receiving the fasteners 144 may be recessed relative to the outer surfaces 142 of the support 78 to avoid contacting the implant 24 as the clamp pads 80 are actuated within the opening 136. Dowel pins 146 are inserted into holes 147 in the clamp pads 80 and into the holes 130 in the pushrod 122 to position the clamp pads 80 relative to the pushrod 122. Fasteners 148, such as screws, attach the cover plates 83 to the support 78. The cover plates 83 may cover a portion of the opening 136 that does not need to be accessible after the clamp pads 80, 82 are assembled.

Fasteners 150 are inserted into the holes 140 in the enclosed end 139 of the support 78 and into holes 153 in the clamp pads 82 to attach the clamp pads 82 to the support 78. The fasteners 150 may be screws, as shown, the holes 140 may be unthreaded, and the holes 153 may be threaded. Fasteners 152 are inserted into the holes 109, 118, and 134 to attach the spacer 76 and the support 78 to the second adapter 72. The fasteners 152 may be socket head screws, as shown, and may be used in conjunction with washers 154.

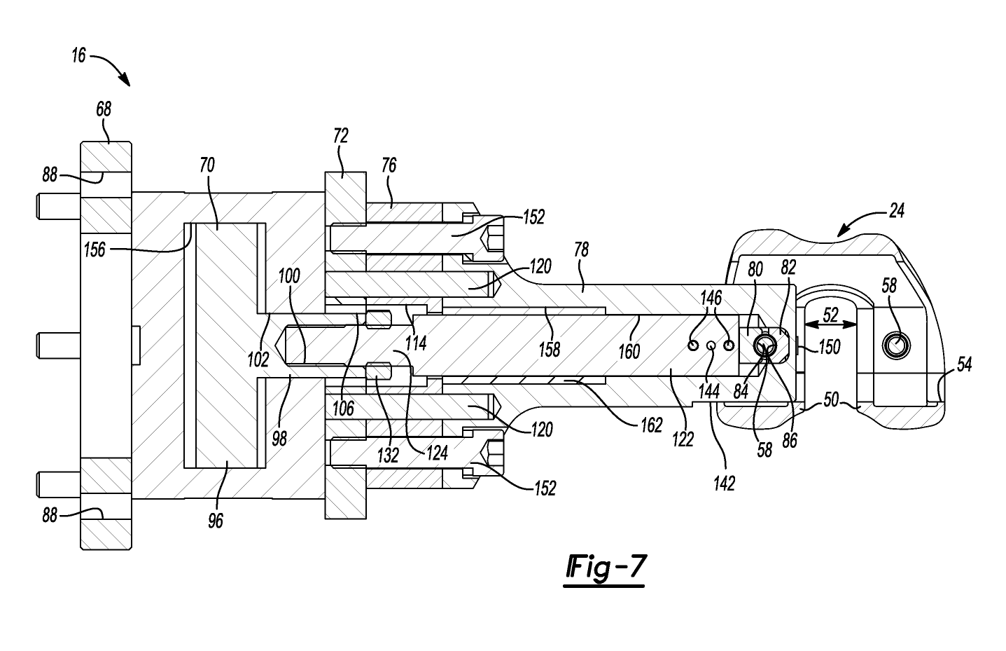

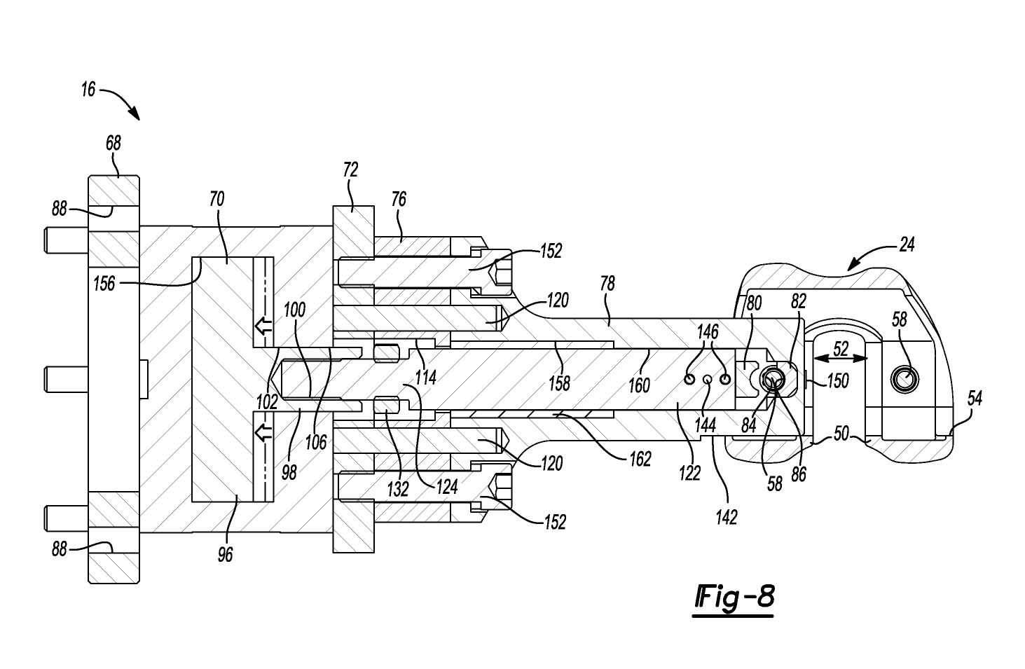

Referring now to FIGS. 7 and 8, inner detail of the gripper 16 is illustrated. The actuator 70 includes a cavity 156 to which the bore 102 extends. Travel of the piston 96 may be limited due to contact between the head of the piston 96 and the cavity 156. The support 78 includes bores 158, 160 and a bushing 162. The bore 158 may have a greater diameter than the bore 160 to accommodate the bushing 162. The pushrod 122 slides within the bore 160 and the bushing 162.

Referring again to FIGS. 4 through 8, operation of the gripper 16 will now be discussed. The gripper 16 engages the inner surfaces 54 of the implant 24 and clamps one of the protrusions 58 on the implant 24 to hold the implant 24 during finishing. Engaging the inner surfaces 54 of the implant 24 locates the implant 24 relative to the gripper 16 and facilitates clamping only one of the protrusions 58 by reducing stress levels in the implant 24 during finishing. Clamping only one of the protrusions 58 avoids the need to extend the part nesting block 30 across the cruiciate gap 52 of the implant 24 when the gripper 16 clamps the implant 24, enabling automated finishing of the cruciate gap 52.

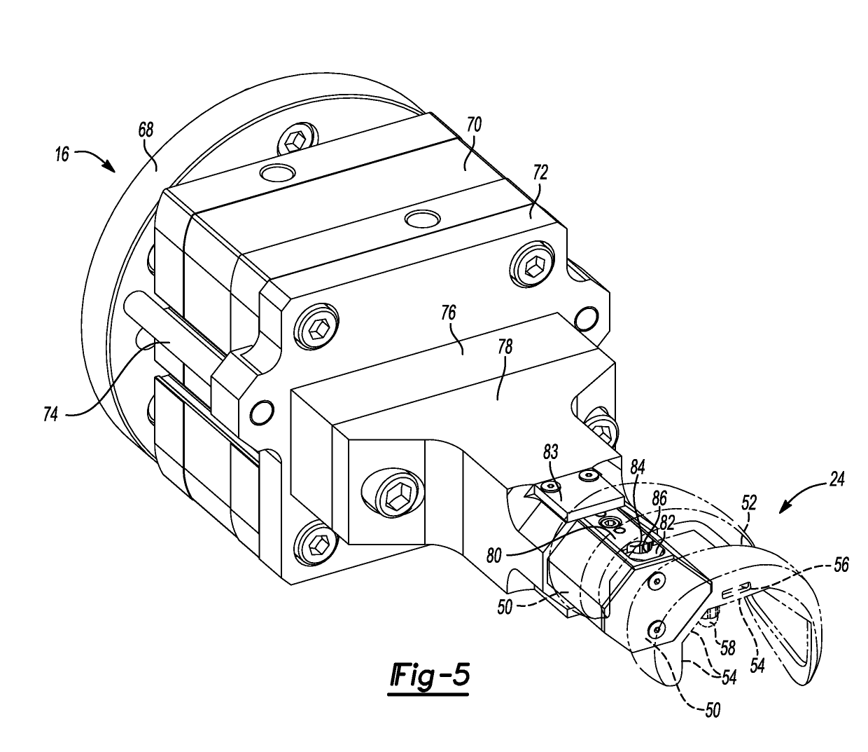

When gripping the implant 24, the robot 14 of FIG. 1 positions the clamp pads 80, 84 of gripper 16 on opposite sides of one of the protrusions 58 of the implant 24. The portion of the gripper 16 that engages the implant 24, including the outer surfaces 142 of the part nesting block 30, are symmetric about a longitudinal mid-plane extending through the gripper 16. This enables the gripper 16 to clamp either of the protrusions 58 on the implant 24, as shown in FIGS. 4 and 5, without being rotated to engage the outer surfaces 142 of the part nesting block 30 with the inner surfaces 54 of the implant 24. In turn, the robot 14 does not need the ability to rotate the gripper 16, which may reduce costs associated with the robot 14.

When the clamp pads 80, 82 are positioned on opposite sides of one of the protrusions 58 on the implant 24, the actuator 70 actuates the piston 96 to move the pushrod 122 and the clamp pad 80 toward the clamp pad 82. Travel of the piston 96, the pushrod 122, and the clamp pad 80 in this direction is stopped when the clamp surfaces 84, 86 of the clamp pads 80, 82 engage the protrusions 58, as shown in FIG. 7. The actuator 70 holds the clamp pad 80 in this position to hold the implant 24 in the gripper 16. When the clamp pads 80, 82 are not positioned about an object, travel of the piston 96, the pushrod 122, and the clamp pad 80 in this direction is limited by contact between the clamp pads 80, 82.

When releasing the implant 24, the actuator 70 actuates the piston 96 to move the pushrod 122 and the clamp pad 80 away from the clamp pad 82. Travel of the piston 96, the pushrod 122, and the clamp pad 80 in this direction is limited by contact between the head of the piston 96 and the bottom of the cavity 156 in the actuator 70, as shown in FIG. 8. However, the actuator 70 may stop travel in this direction prior to encountering this limit.

The amount by which the clamp pads 80, 82 may be separated to accommodate various protrusions 58 on the implant 24 is governed by the travel limit in the releasing direction. However, the clamp pads 80, 82 may be shaped and sized to conform to the shapes and sizes of the protrusions 58 on the implant 24. In addition, the depth to which the pushrod 122 is threaded in the piston 96 may be adjusted to accommodate protrusions 58 having various shapes and sizes.

Since the clamp pads 80, 82 may be detached from the pushrod 122, the clamp pads 80, 82 may be replaced with clamp pads having different shapes or sizes to accommodate the protrusions 58 when gripping or releasing. In addition, the clamp pads 80, 82 may be replaced as the clamp surfaces 84, 86 on the clamp pads 80, 82 wear out. Replacing the clamp pads 80, 82 and/or varying the threaded depth of the pushrod 122 in the piston 96 to accommodate the protrusions 58 may save costs relative to other modifications to the gripper 16.

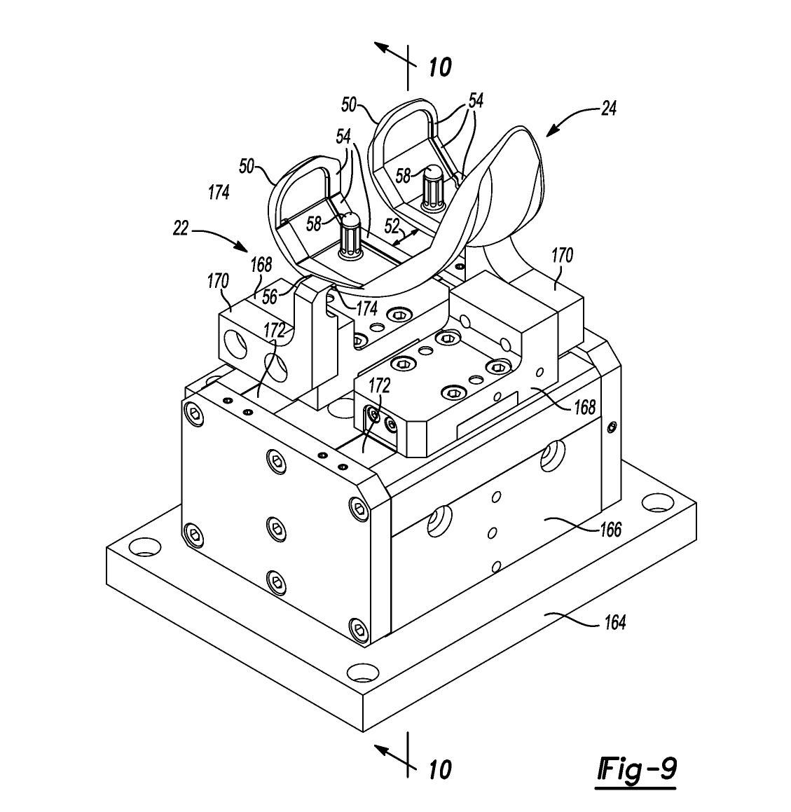

Referring to FIG. 9, the regrip fixture 22 includes a base block 164, an actuator 166, adapters 168, and fingers 170. The base block 164 may includes holes, such as those shown, in which fasteners may be inserted to fix the base block 164 to, for example, a bedplate. The actuator 166 includes slide tracks 172 to which the adapters 168 attach. The adapters 168 may be attached to the tracks 172 using fasteners, such as the socket head screws shown. The fingers 170 include tabs 174 and are attached to the adapters 168. The fingers 170 may be attached to the adapters 168 using fasteners, such as socket head screws. The tabs 174 are shaped and sized to be inserted into and engage the notches 56 in the implant 24.

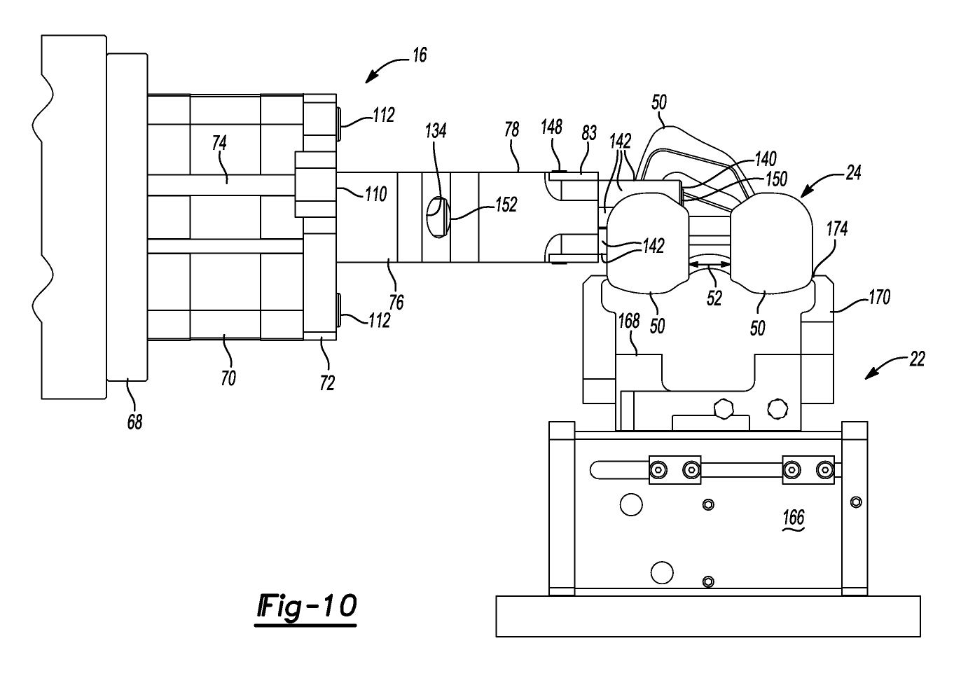

With additional reference to FIGS. 10 through 12, operation of the regrip fixture 22 will now be discussed. The regrip fixture 22 holds the implant 24 by the notches 56 in the implant 24 while the robot 14 switches from holding one of the protrusions 58 to holding another one of the protrusions 58. To enable the regrip fixture 22 to grip the implant 24, the robot 14 positions the notches 56 in the implant 24 adjacent to the tabs 174 of the fingers 170, as shown in FIG. 10.

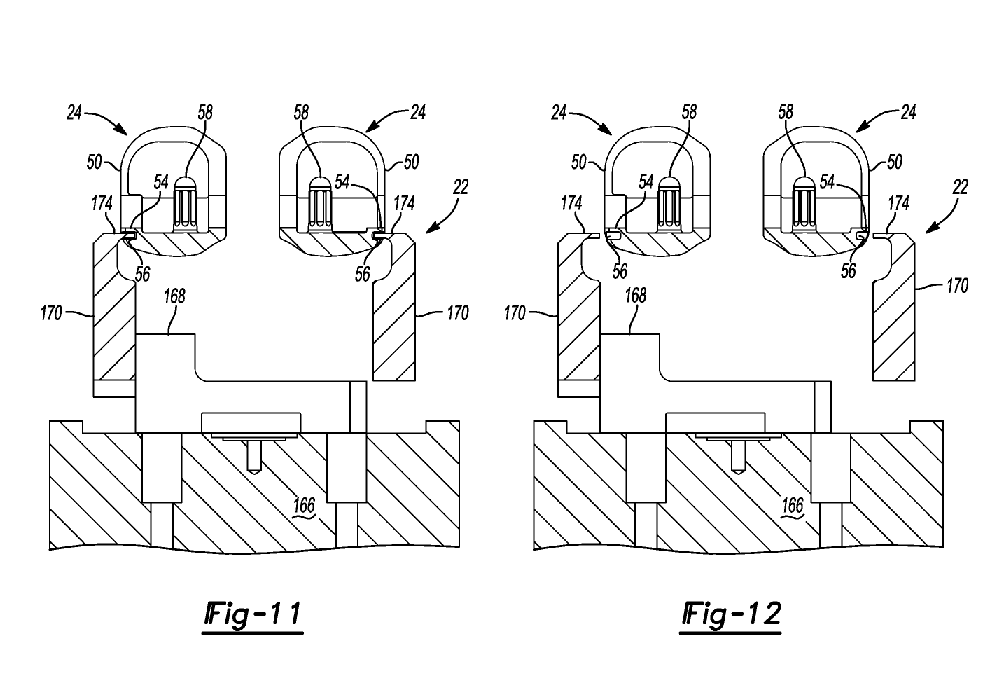

When gripping the implant 24, the regrip fixture 22 actuates the adapters 168 and the fingers 170 along the length of the track 172 to move the tabs 174 on the fingers 170 toward the notches 56 in the implant 24. The regrip fixture 22 stops actuating the tabs 174 in this direction when the tabs 174 bottom out in the notches 56, as shown in FIG. 11. In this position, the engagement between the tabs 174 on the fingers 170 and the notches 56 in the implant 24 holds the implant 24. While the regrip fixture 22 holds the implant 24, the robot 14 moves to the opposite side of the implant 24 to grab another one of the protrusions 58 on the implant 24.

When releasing the implant 24, the regrip fixture 22 actuates the adapters 168 and the fingers 170 along the length of the track 172 to move the tabs 174 on the fingers 170 away from the notches 56 in the implant 24. The regrip fixture 22 stops actuating the tabs 174 in this direction when the tabs 174 are removed from the notches 56, as shown in FIG. 12. Travel in this direction is limited by the travel limits of the actuator 166. However, the adapters 168 and/or the fingers 170 may be modified to accommodate various implant shapes and sizes.

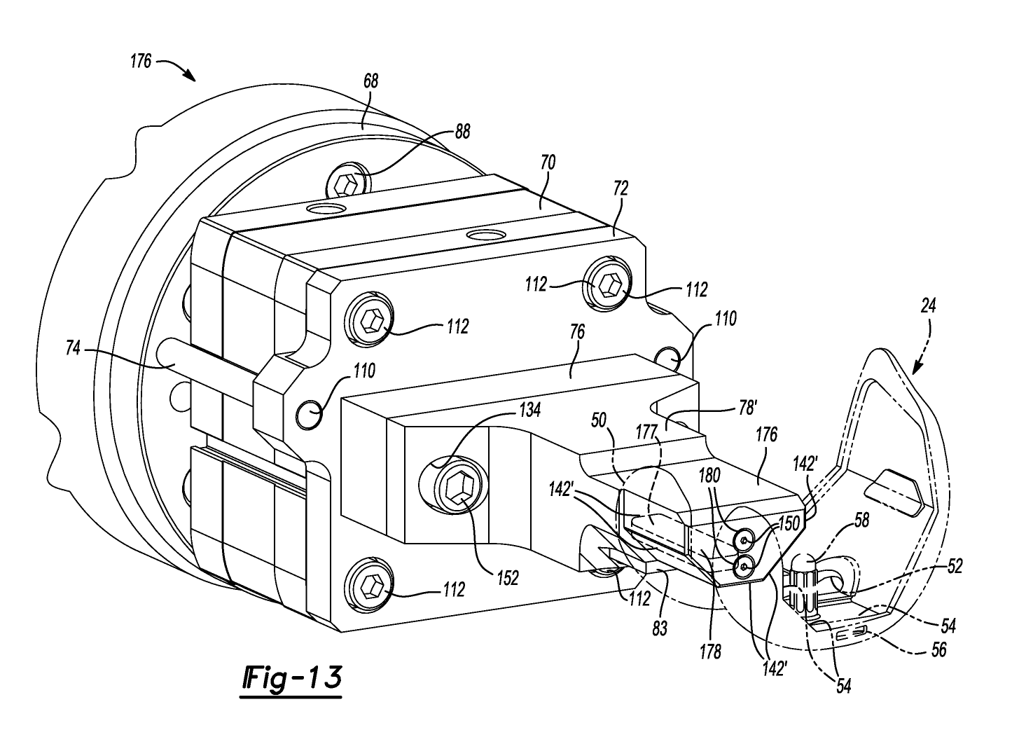

Referring now to FIG. 13, a direct clamp gripper 16′ is substantially similar to the direct clamp gripper 16 such that only differences between the grippers 16, 16′ will now be discussed. In contrast to the gripper 16, the portion of the gripper 16′ that engages the implant 24 is not symmetric about a longitudinal mid-plane extending through the gripper 16′. Thus, the gripper 16′ must be rotated as the gripper 16′ transitions between clamping the protrusions 58 on the implant 24. However, the gripper 16′ may require less material and less machining operations as compared to the gripper 16, thereby saving costs associated with the gripper 16′.

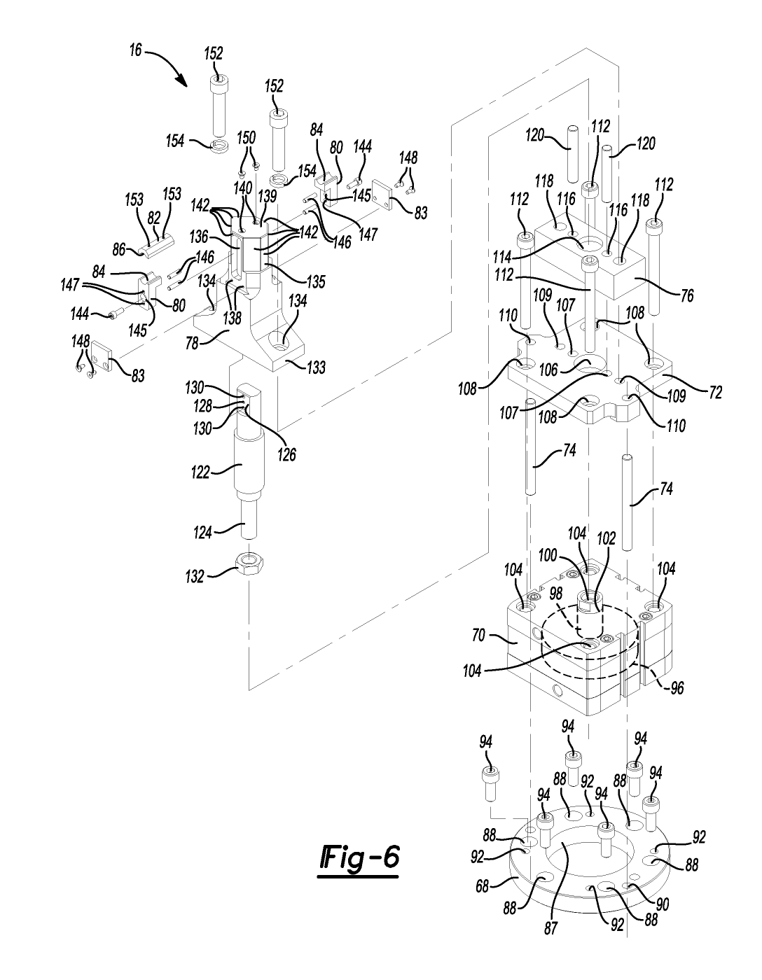

The gripper 16′ includes an engaging portion 175 including a flat surface 176, an opening 177, and an enclosed end 178. The engaging portion 175 has a hexagonal shape rather than the octagonal shape of the engaging portion 135 of FIG. 6. The flat surface 176 extends between two of the surfaces 142′ shown as parallel and vertical in FIG. 13, and the flat surface 176 is opposite one of the surfaces 142′ shown as horizontal in FIG. 13. The flat surface 176 may be positioned in the vertical direction of FIG. 13 such that the height of the two parallel surfaces 142′ is equal to the height of the two corresponding surfaces 142 of FIG. 6. The opening 177 extends only partially through the engaging portion 175, as the opening 177 does not extend through the flat surface 176. The enclosed end 178 includes holes 180 that are in different positions relative to the holes 140 in the enclosed end 139 of FIG. 6. This difference in the positions of the holes 140, 180 is due to the geometric differences between the engaging portions 135, 175.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A gripper for finishing a part using a robot, the part including fingers and a gap between the fingers, each of the fingers having an inner surface with a protrusion extending from the inner surface, the gripper comprising:
a support including a first bore, an opening, and an outer surface, the first bore extending at least partially through the support along a length thereof, the opening extending at least partially through the support normal to the first bore, and the outer surface being shaped to substantially conform to the inner surface of the part;
a first pad and a second pad disposed within the first bore and including opposing clamp surfaces, the clamp surfaces being exposed through the opening and shaped to substantially conform to the protrusion on the part; and
a pushrod disposed within the first bore and adapted to couple the first pad to an actuator, the pushrod being slideable within the first bore to actuate the first pad relative to the second pad and to selectively clamp the protrusion on the part between the first pad and the second pad with the clamp surfaces.

2. The gripper of claim 1, wherein the outer surface of the support engages the inner surface of one of the fingers without extending across the gap between the fingers when the protrusion on the part is clamped between the first pad and the second pad.

3. The gripper of claim 1, wherein the part is a femoral knee implant, the fingers are condyles, the gap is a cruciate gap, and the protrusion is a post.

4. The gripper of claim 1, wherein the support includes an enclosed end, the second pad being disposed adjacent to and attached to the enclosed end.

5. The gripper of claim 1, further comprising the actuator and a first adapter configured to couple the actuator to the robot.

6. The gripper of claim 5, further comprising a second adapter coupling the support to the actuator and including a second bore coaxially aligned with the first bore in the support.

7. The gripper of claim 6, wherein the actuator is a pneumatic cylinder including a piston, the piston including a cavity coaxially aligned with the first bore in the support and receiving the pushrod therein.

8. The gripper of claim 7, wherein the pushrod includes outer threads engaging inner threads of the piston, and a nut is threaded onto the outer threads of the pushrod and abutting the piston, the nut preventing relative movement between the pushrod and the piston.

9. The gripper of claim 1, wherein the outer surface extends around a perimeter of the support and the opening extends through the support such that the gripper is adapted to receive the protrusion at opposite ends of the opening.

10. The gripper of claim 1, wherein the support includes a flat surface opposite the outer surface and the opening extends only partially through the support.

11. The gripper of claim 1, wherein the protrusion is cylindrical and the clamp surfaces each include a semi-circular profile conforming to the protrusion.

12. The gripper of claim 1, wherein the outer surface includes a first surface, a second surface that is oriented at a reflex angle relative to the first surface, and a third surface that is oriented at a right angle relative to the first surface.

13. A finishing system for finishing a part using a robot, the part including an inner surface, a protrusion, and a notch, the robotic finishing system comprising:
a staging fixture including first pads adapted to engage the protrusion;
a gripper adapted to couple to the robot and including a first outer surface and second pads, the first outer surface being shaped to engage the inner surface of the part, the second pads being adapted to clamp the protrusion on the part; and
a regrip fixture including a tab adapted to engage the notch.

14. The finishing system of claim 13, wherein the first outer surface of the gripper engages the inner surface of the part when the second pads clamp the protrusion on the part.

15. The finishing system of claim 13, wherein the first outer surface of the gripper substantially conforms to the inner surface of the part.

16. The finishing system of claim 13, wherein the staging fixture includes a first coupler adapted to couple one of the first pads to a first actuator.

17. The finishing system of claim 13, wherein the gripper includes a second coupler adapted to couple one of the second pads to a second actuator.

18. The finishing system of claim 13, wherein the staging fixture includes an actuator, a coupler, and a support, the support housing the first pads, the coupler coupling the support to the actuator, and the actuator being operable to actuate one of the first pads and thereby clamp the protrusion of the part between the first pads.

19. The finishing system of claim 18, wherein the support is configured to avoid contacting the part when the first pads engage the protrusion on the part.

20. The finishing system of claim 13, wherein the staging fixture includes a proximity sensor that detects a presence of the protrusion between the first pads.

21. The finishing system of claim 13, wherein the regrip fixture includes an actuator, a coupler, and a finger including the tab, the coupler coupling the finger to the actuator, and the actuator being operable to insert the tab into the notch.
